(19) United States
(12) Patent Application Publication
(10) Pub. No.: US 2022/0289195 A1
(43) Pub. Date: Sep. 15, 2022

(54) PROBABILISTIC ADAPTIVE RISK HORIZON FOR EVENT AVOIDANCE AND MITIGATION IN AUTOMATED DRIVING

(71) Applicant: GM GLOBAL TECHNOLOGY OPERATIONS LLC, Detroit, MI (US)

(72) Inventors: Mohammadali Shahriari, Markham (CA); Reza Zarringhalam, Whitby (CA); Venkataramana Venigalla, Novi, MI (US); Jason M France, Ann Arbor, MI (US); Dmitriy Feldman, West Bloomfield, MI (US); Kevin Gady, Saline, MI (US)

(73) Assignee: GM GLOBAL TECHNOLOGY OPERATIONS LLC, Detroit, MI (US)

(21) Appl. No.: 17/202,123

(22) Filed: Mar. 15, 2021

(51) Int. Cl. B60W 30/18; H04W 4/46; B60W 30/08; G08G 1/00

(52) U.S. Cl. CPC B60W 30/18; H04W 4/46; B60W 30/08; G08G 1/22; B60W 2520/12; B60W 2520/10

(57) ABSTRACT

In an exemplary embodiment, a system is provided that includes one or more first sensors, one or more second sensors, and a processor. The one or more first sensors are disposed onboard a host vehicle, and are configured to at least facilitate obtaining first sensor data with respect to the host vehicle. The one or more second sensors are disposed onboard the host vehicle and configured to at least facilitate obtaining second sensor data with respect to a target vehicle that is in proximity to the host vehicle. The processor is coupled to the one or more first sensors and the one or more second sensors, and is configured to at least facilitate: creating an adaptive prediction horizon that includes a probabilistic time-to-event horizon with respect to possible vehicle events between the host vehicle and the target vehicle; and controlling the host vehicle based on the probabilistic time-to-event horizon.

### TECHNICAL FIELD

The technical field generally relates to vehicles and, more specifically, to methods and systems for controlling a vehicle in avoiding and mitigating events with a target vehicle.

### BACKGROUND

Certain vehicles today include systems for avoiding and mitigating vehicle events, such as when a host vehicle would contact a target vehicle. However, such existing vehicle systems may not always provide optimal avoidance and mitigation in certain situations.

Accordingly, it is desirable to provide improved methods and systems for controlling vehicles in avoiding and mitigating vehicle events with a target vehicle.

### SUMMARY

In accordance with an exemplary embodiment, a system is provided that includes one or more first sensors, one or more second sensors, and a processor. The one or more first sensors are disposed onboard a host vehicle, and are configured to at least facilitate obtaining first sensor data with respect to the host vehicle. The one or more second sensors are disposed onboard the host vehicle and configured to at least facilitate obtaining second sensor data with respect to a target vehicle that is in proximity to the host vehicle. The processor is coupled to the one or more first sensors and the one or more second sensors, and is configured to at least facilitate: creating an adaptive prediction horizon that includes a probabilistic time-to-event horizon with respect to possible vehicle events between the host vehicle and the target vehicle; and controlling the host vehicle based on the probabilistic time-to-event horizon.

Also in an exemplary embodiment, the processor is further configured to at least facilitate simultaneously controlling lateral and longitudinal movement of the host vehicle based on the probabilistic time-to-event horizon.

Also in an exemplary embodiment, the processor is further configured to at least facilitate: estimating prediction uncertainties for the adaptive predictive risk horizon, using respective uncertainties associated with one or more of the first sensors, second sensors, or both; generating a corrected probabilistic time-to-event horizon using the prediction uncertainties; and controlling the host vehicle based on the corrected probabilistic time-to-event horizon.

Also in an exemplary embodiment, the processor is further configured to at least facilitate: generating a probabilistic risk horizon for the adaptive prediction horizon; and controlling the host vehicle based on both the probabilistic time-to-event horizon and the probabilistic risk horizon.

Also in an exemplary embodiment, the processor is further configured to at least facilitate: generating a predictive potential event zone using the first sensor data and the second sensor data; and calculating a risk of specific events associated with the potential event zone.

Also in an exemplary embodiment, the processor is further configured to at least facilitate: generating a category for control based on both the probabilistic time-to-event horizon and the probabilistic risk horizon; and controlling the host vehicle based on both the probabilistic time-to-event horizon and the probabilistic risk horizon, based on the category for control.

Also in an exemplary embodiment, the processor is further configured to at least facilitate generating the category for control from a plurality of different category groupings, including: a first category grouping representing a first level of urgency, and calling for a notification to be provided to a driver or other user of the host vehicle; a second category grouping representing a second level of urgency, greater than the first level of urgency, and calling for mission planning control to be provided for the host vehicle in accordance with instructions provided by the processor; and a third category grouping representing a third level of urgency, greater than both the first level of urgency and the second level of urgency, and calling for reactive planning control to be provided for the host vehicle in accordance with instructions provided by the processor.

Also in an exemplary embodiment, the processor is further configured to at least facilitate controlling steering for the host vehicle based on the probabilistic time-to-event horizon.

Also in an exemplary embodiment, the processor is further configured to at least facilitate controlling lateral and longitudinal movement of the host vehicle based on the probabilistic time-to-event horizon.

In another exemplary embodiment, a method is provided that includes: obtaining first sensor data with respect to a host vehicle, from one or more first sensors onboard the host vehicle; obtaining second sensor data with respect to a target vehicle that is in proximity to the host vehicle, form one or more second sensors onboard the host vehicle; creating, via a processor onboard the host vehicle, an adaptive prediction horizon that includes a probabilistic time-to-event horizon with respect to possible vehicle events between the host vehicle and the target vehicle; and controlling the host vehicle based on the probabilistic time-to-event horizon via instructions provided by the processor.

Also in an exemplary embodiment, the step of controlling the host vehicle includes providing a notification to a user of the host vehicle, in accordance with instructions provided by the processor, based on the probabilistic time-to-event horizon.

Also in an exemplary embodiment, the step of controlling the host vehicle includes simultaneously controlling lateral and longitudinal movement of the host vehicle, in accordance with instructions provided by the processor, based on the probabilistic time-to-event horizon.

Also in an exemplary embodiment, the method further includes: estimating, via the processor, prediction uncertainties for the adaptive predictive risk horizon, using respective uncertainties associated with one or more of the first sensors, second sensors, or both; and generating, via the processor, a corrected probabilistic time-to-event horizon using the prediction uncertainties; wherein the step of controlling the host vehicle includes controlling the host vehicle based on the corrected probabilistic time-to-event horizon.

Also in an exemplary embodiment, the method further includes: generating, via the processor, a probabilistic risk horizon for the adaptive prediction horizon; wherein the step of controlling the host vehicle includes controlling the host vehicle based on both the probabilistic time-to-event horizon and the probabilistic risk horizon, via instructions provided by the processor.

Also in an exemplary embodiment, the generating of the problematic risk horizon includes: generating a predictive potential event zone using the first sensor data and the second sensor data; and calculating a risk of specific events associated with the potential event zone.

Also in an exemplary embodiment, the method further includes: generating, via the processor, a category for control based on both the probabilistic time-to-event horizon and the probabilistic risk horizon; wherein the step of controlling the host vehicle includes controlling the host vehicle based on both the probabilistic time-to-event horizon and the probabilistic risk horizon, via instructions provided by the processor, with the instructions based on the category for control.

Also in an exemplary embodiment, the category for control is generated from a plurality of different category groupings, including: a first category grouping representing a first level of urgency, and calling for a notification to be provided to a driver or other user of the host vehicle; a second category grouping representing a second level of urgency, greater than the first level of urgency, and calling for mission planning control to be provided for the host vehicle in accordance with instructions provided by the processor; and a third category grouping representing a third level of urgency, greater than both the first level of urgency and the second level of urgency, and calling for reactive planning control to be provided for the host vehicle in accordance with instructions provided by the processor.

In another exemplary embodiment, a vehicle is provided that includes: a body, a propulsion system, one or more first sensors, one or more second sensors, and a processor. The propulsion system is configured to generate movement of the body. The one or more first sensors is disposed onboard a host vehicle, and is configured to at least facilitate obtaining first sensor data with respect to the host vehicle. The one or more second sensors are disposed onboard the host vehicle, and are configured to at least facilitate obtaining second sensor data with respect to a target vehicle that is in proximity to the host vehicle. The processor is coupled to the one or more first sensors and the one or more second sensors, and is configured to at least facilitate: creating an adaptive prediction horizon that includes a probabilistic time-to-event horizon with respect to possible vehicle events between the host vehicle and the target vehicle; and controlling the host vehicle based on the probabilistic time-to-event horizon.

Also in an exemplary embodiment, the processor is further configured to at least facilitate: estimating prediction uncertainties for the adaptive predictive risk horizon, using respective uncertainties associated with one or more of the first sensors, second sensors, or both; generating a corrected probabilistic time-to-event horizon using the prediction uncertainties; and controlling the host vehicle based on the corrected probabilistic time-to-event horizon.

Also in an exemplary embodiment, the processor is further configured to at least facilitate: generating a probabilistic risk horizon for the adaptive prediction horizon; and controlling the host vehicle based on both the probabilistic time-to-event horizon and the probabilistic risk horizon.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a control system for controlling a vehicle with respect to avoiding and mitigating vehicle events with a target vehicle, in accordance with exemplary embodiments;

FIG. 2 is a flowchart of a process for controlling a vehicle with respect to avoiding and mitigating vehicle events with a target vehicle, and that can be implemented in connection with the vehicle of FIG. 1, in accordance with exemplary embodiments; and

FIGS. 3-5 depict illustrative implementations of the process of FIG. 2, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

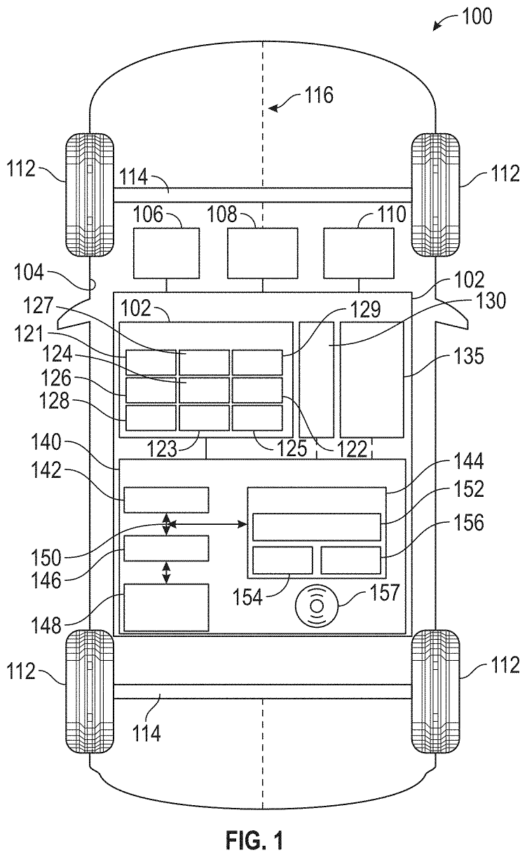

FIG. 1 illustrates a vehicle 100 (also referred to herein as the “host vehicle” 100), according to an exemplary embodiment. As described in greater detail further below, the vehicle 100 includes a control system 102 for controlling the vehicle 100 while avoiding or mitigating vehicle events other vehicles. As used herein, the term “event” or “vehicle event” includes an occurrence when one vehicle contacts another vehicle (also referred to herein as a “target vehicle”).

In various embodiments, the vehicle 100 comprises an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle, such as aircraft, spacecraft, watercraft, and so on, and/or one or more other types of mobile platforms (e.g., a robot and/or other mobile platform).

The vehicle 100 includes a body 104 that is arranged on a chassis 116. The body 104 substantially encloses other components of the vehicle 100. The body 104 and the chassis 116 may jointly form a frame. The vehicle 100 also includes a plurality of wheels 112. The wheels 112 are each rotationally coupled to the chassis 116 near a respective corner of the body 104 to facilitate movement of the vehicle 100. In one embodiment, the vehicle 100 includes four wheels 112, although this may vary in other embodiments (for example for trucks and certain other vehicles).

A drive system 110 is mounted on the chassis 116, and drives the wheels 112, for example via axles 114. The drive system 110 preferably comprises a propulsion system. In certain exemplary embodiments, the drive system 110 comprises an internal combustion engine and/or an electric motor/generator, coupled with a transmission thereof. In certain embodiments, the drive system 110 may vary, and/or two or more drive systems 112 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

As depicted in FIG. 1, the vehicle also includes a braking system 106 and a steering system 108 in various embodiments. In exemplary embodiments, the braking system 106 controls braking of the vehicle 100 using braking components that are controlled via inputs provided by a driver (e.g., via a braking pedal in certain embodiments) and/or automatically via the control system 102. Also in exemplary embodiments, the steering system 108 controls steering of the vehicle 100 via steering components (e.g., a steering column coupled to the axles 114 and/or the wheels 112) that are controlled via inputs provided by a driver (e.g., via a steering wheel in certain embodiments) and/or automatically via the control system 102.

In the embodiment depicted in FIG. 1, the control system 102 is coupled to the braking system 106, the steering system 108, and the drive system 110. Also as depicted in FIG. 1, in various embodiments, the control system 102 includes a sensor array 120, a location system 130, a display system 135, and a controller 140.

In various embodiments, the sensor array 120 includes various sensors that obtain sensor data for use in tracking road elevation and controlling the vehicle 10 based on the road elevation. In the depicted embodiment, the sensor array 120 includes inertial measurement sensors 121, input sensors 122 (e.g., brake pedal sensors measuring brake inputs provided by a driver and/or touch screen sensors and/or other input sensors configured to received inputs from a driver or other user of the vehicle 10); steering sensors 123 (e.g., coupled to a steering wheel and/or wheels of the vehicle 10 and configured to measure a steering angle thereof), tire sensors 124 (e.g., to measure pressure of one or more tires of the vehicle 100), speed sensors 125 (e.g., wheel speed sensors and/or other sensors configured to measure a speed and/or velocity of the vehicle and/or data used to calculate such speed and/or velocity), mass sensors 129 (e.g., to measure a mass of the vehicle 100 and/or one or more components thereof), cameras 126 (e.g., configured to obtain camera images, for example with respect to other vehicles on the roadway), lidar sensors 127 (e.g., configured to obtain lidar data, for example with respect to other vehicles on the roadway), radar sensors 128 (e.g., configured to obtain radar data, for example with respect to other vehicles on the roadway), and/or one or more other sensors 131 (e.g. including one or more other ultrasonic sensors configured to obtain data, for example with respect to other vehicles on the roadway).

Also in various embodiments, the location system 130 is configured to obtain and/or generate data as to a position and/or location in which the vehicle is located and/or is travelling. In certain embodiments, the location system 130 comprises and/or or is coupled to a satellite-based network and/or system, such as a global positioning system (GPS) and/or other satellite-based system.

In various embodiments, the display system 135 provides notifications to a driver or other user of the vehicle 100. In various embodiments, the display system 135 provides audio, visual, haptic, and/or other notifications when a potential event between the vehicle 100 and one or more target vehicles is determined, such that the driver or user may take appropriate corrective action.

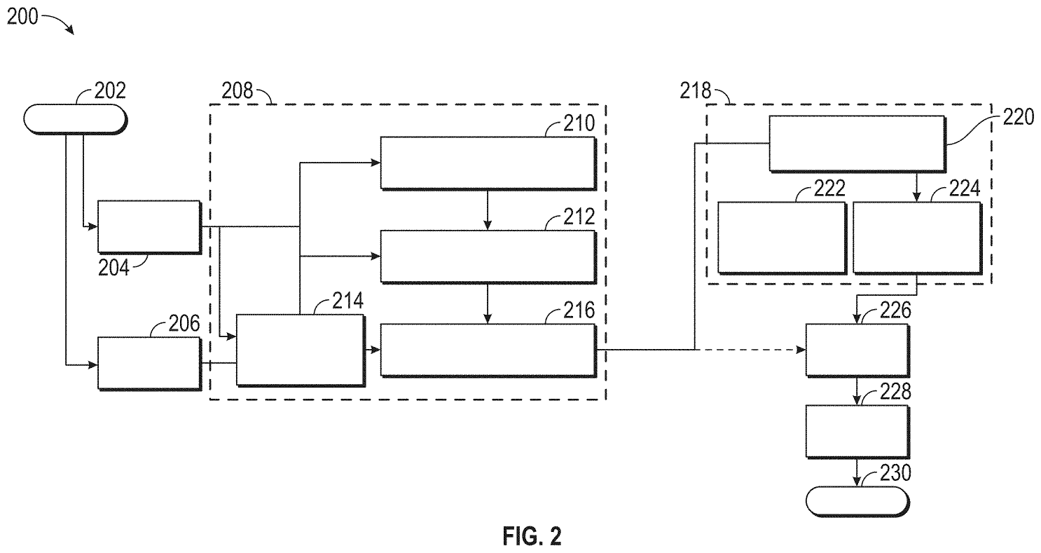

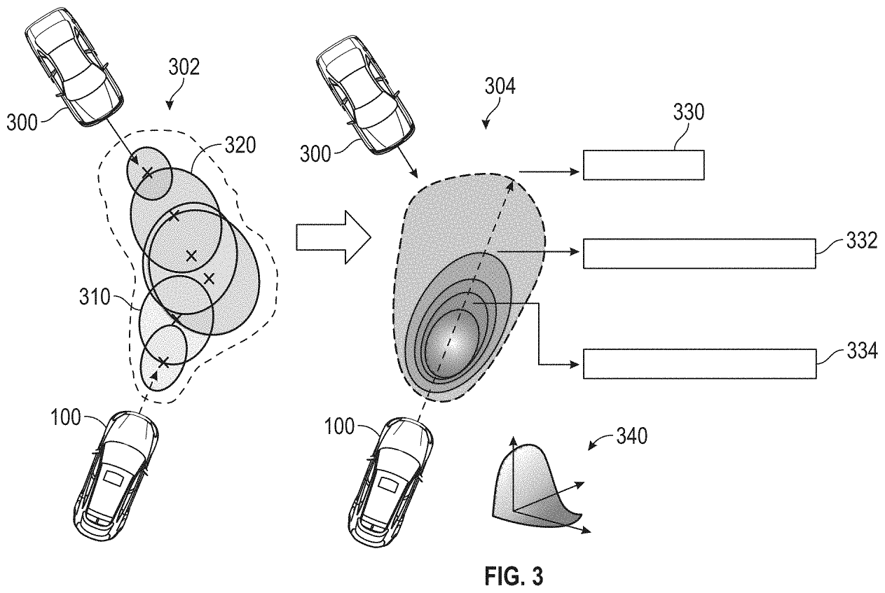

In various embodiments, the controller 140 is coupled to the sensor array 120, the location system 130, and the display system 135. Also in various embodiments, the controller 140 comprises a computer system (also referred to herein as computer system 14), and includes a processor 142, a memory 144, an interface 146, a storage device 148, and a computer bus 150. In various embodiments, the controller (or computer system) 140 controls vehicle operation, including avoidance and mitigation of vehicle events, based on the data from the sensor array 120. In various embodiments, the controller 140 provides these and other functions in accordance with the steps of the process of FIG. 2 and the implementations of FIGS. 3-5.

In various embodiments, the controller 140 (and, in certain embodiments, the control system 102 itself) is disposed within the body 104 of the vehicle 100. In one embodiment, the control system 102 is mounted on the chassis 116. In certain embodiments, the controller 104 and/or control system 102 and/or one or more components thereof may be disposed outside the body 104, for example on a remote server, in the cloud, or other device where image processing is performed remotely.

It will be appreciated that the controller 140 may otherwise differ from the embodiment depicted in FIG. 1. For example, the controller 140 may be coupled to or may otherwise utilize one or more remote computer systems and/or other control systems, for example as part of one or more of the above-identified vehicle 100 devices and systems.

In the depicted embodiment, the computer system of the controller 140 includes a processor 142, a memory 144, an interface 146, a storage device 148, and a bus 150. The processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the controller 140 and the computer system of the controller 140, generally in executing the processes described herein, such as the process 200 discussed further below in connection with FIG. 2 and the implementations of FIGS. 2-5.

The memory 144 can be any type of suitable memory. For example, the memory 144 may include various types of dynamic random access memory (DRAM) such as SDRAM, the various types of static RAM (SRAM), and the various types of non-volatile memory (PROM, EPROM, and flash). In certain examples, the memory 144 is located on and/or co-located on the same computer chip as the processor 142. In the depicted embodiment, the memory 144 stores the above-referenced program 152 along with map data 154 (e.g., from and/or used in connection with the location system 130) and one or more stored values 156 (e.g., including, in various embodiments, threshold values of time and/or distance with respect to a possible event between the vehicle 100 and one or more target vehicles on the roadway).

The bus 150 serves to transmit programs, data, status and other information or signals between the various components of the computer system of the controller 140. The interface 146 allows communication to the computer system of the controller 140, for example from a system driver and/or another computer system, and can be implemented using any suitable method and apparatus. In one embodiment, the interface 146 obtains the various data from the sensor array 120 and/or the location system 130. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 152 that executes one or more embodiments of one or more processes of the present disclosure, such as the steps of the process 200 discussed further below in connection with FIG. 2 and the implementations of FIGS. 3-5. In another exemplary embodiment, the program product may be directly stored in and/or otherwise accessed by the memory 144 and/or a disk (e.g., disk 157), such as that referenced below.

The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non- transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 140 may also otherwise differ from the embodiment depicted in FIG. 1, for example in that the computer system of the controller 140 may be coupled to or may otherwise utilize one or more remote computer systems and/or other control systems.

FIG. 2 is a flowchart of a process 200 for controlling a vehicle with respect to avoiding and mitigating vehicle events with a target vehicle, in various embodiments. The process 200 can be implemented in connection with the vehicle 100 of FIG. 1, in accordance with exemplary embodiments. The process 200 of FIG. 2 will also be discussed further below in connection and FIGS. 3-5, which show different implementations of the process 200 in accordance with various embodiments.

As depicted in FIG. 2, the process begins at step 202. In one embodiment, the process 200 begins when a vehicle drive or ignition cycle begins, for example when a driver approaches or enters the vehicle 100, or when the driver turns on the vehicle and/or an ignition therefor (e.g. by turning a key, engaging a keyfob or start button, and so on). In one embodiment, the steps of the process 200 are performed continuously during operation of the vehicle.

In various embodiments, sensor data is obtained with respect to both: (i) target vehicles and/or other objects on the roadway in which the vehicle 100 is travelling (step 204) and (ii) states of the vehicle 100 itself (step 206).

In various embodiments, during step 204, data is obtained with respect to one or more other vehicles on or near the roadway on which the vehicle 100 is travelling (referred to herein as “target vehicles”). While the term “target vehicles” is used herein, it will be appreciated that in various embodiments this may also refer to one or more other objects that may not be vehicles (such as, by way of example, trees, rocks, pedestrians, traffic lights, infrastructure, and the like). In various embodiments, during step 204 data is obtained by one or more cameras 126, lidar sensors 127, radar sensors 128, and/or other sensors 131 of FIG. 1 with respect to one or more such “target vehicles”.

In various embodiments, during step 206, data is obtained with respect to one or more states of the host vehicle 100 itself. In various embodiments, during step 206 sensor data is obtained by one or more inertial measurement unit (IMU) sensors 121 (e.g., IMU data), input sensors 122 (e.g., including a destination of travel for the vehicle 100 for the current vehicle drive, engagement of the braking steering system 108, and/or drive system 110 by a driver or other user, a driver or user's override of one or more automated features of the vehicle 100, and so on), tire sensors 124 (e.g., including tire pressure), speed sensors 125 (e.g., a speed of the vehicle 100 and/or wheels 112 thereof), mass sensors 129 (e.g., a mass or weight of the vehicle 100 and/or one or more components thereof), and so on.

In various embodiments, the sensor data as to both the target vehicle (i.e., of step 204) and the host vehicle 100 itself (i.e., of step 206) are utilized together to generate a probabilistic time-to-event horizon 208 via steps 210-216, described below.

Specifically, in various embodiments, an adaptive prediction horizon is generated for the vehicle 100 (step 210). In various embodiments, the processor 142 of FIG. 1 generates the adaptive prediction horizon with respect to a road and/or path (collectively referred to herein as a “roadway”) in front of the vehicle 100, with respect to a receding horizon (e.g., with respect to time and/or distance).

In various embodiments, during step 210, a motion model is utilized for both the host vehicle 100 (X_{host,k}) and the target vehicle (X_{target,k})in accordance with the following equation:

\hat{X}ₖ=AₖXₖ₋₁+Bₖuₖ+εₖ, εₖ˜N(0,Rₖ) (Equation 1).

Also during step 210 in various embodiments, a measurement model is also utilized in accordance with the following equation:

Ŷₖ=CₖXₖ+Δₖ, Δₖ˜N(0,Qₖ) (Equation 2).

Also in various inputs, probabilistic future states of the vehicles \hat{X}_{k+f} can be calculated by assuming piecewise constant Aₖ and Bₖ and update for A_{k+f} and B_{k+f}.

With reference to FIG. 3, a first graphical representation 302 of FIG. 3 depicts the host vehicle 100 in proximity to a target vehicle 300, along with various first probabilistic regions 310 for the host vehicle 100 and second probabilistic regions 320 for the target vehicle 300. As shown in a second graphical representation 304 of FIG. 3 and described in greater detail further below, in various embodiments different respective control zones 330, 332, and 334 are generated based on the first and second probabilistic regions 310, 320 for control of the host vehicle 100.

With reference back to FIG. 2, in various embodiments, a probabilistic time-to-event is calculated (step 212). In various embodiments, the processor 142 of FIG. 1 calculates the probabilistic “time-to-event” as an estimated amount of time in which a vehicle event may occur between the vehicle 100 and a target vehicle under current trajectories of both the vehicle 100 and the target vehicle 100.

In various embodiments, during step 212, a probabilistic relative distance \hat{D}ₖ between the host vehicle 100 and the target vehicle is first calculated in accordance with the following equation:

\hat{D}ₖ=\hat{X}_{host,k}−\hat{X}_{target,k} (Equation 3).

where \hat{X}_{host,k}, \hat{X}_{target,k} are the host vehicle's and target vehicle's probabilistic positions, respectively.

Also in various embodiments, as part of step 212, a change in velocity in the direction of the relative distance vector (e.g., a component that may result in a vehicle event) \dot{\hat{D}}ₖ is calculated in accordance with the following equation:

$${\hat{\dot{D}}}_{k} = \frac{{\hat{D}}_{k}}{‖ {\hat{D}}_{k} ‖} \cdot Δ {\hat{ν}}_{( h , t ) , k} . \qquad ( Equation 5 )$$

where Δ\hat{v}_{(h,t),k} is defined as

Δ\hat{υ}_{(h,t),k}=\dot{\hat{X}}_{host,k}−\dot{\hat{X}}_{target,k} (Equation 4).

where \dot{\hat{X}}_{host,k}, \dot{\hat{X}}_{target,k} are the host vehicle's and target vehicle's probabilistic velocity vectors, respectively.

Thus, in accordance with various embodiments, a probabilistic time-to-event at time “k” can be calculated in accordance with the following equation:

$$= \frac{‖ {\hat{D}}_{k} ‖}{{\hat{\dot{D}}}_{k}} . \qquad ( Equation 6 )$$

Also in various embodiments, the time-to-event at time “k+f” can similarly be determined by predicting the states \hat{X}_{host,k+f}, \hat{X}_{target,k+f} and by calculating \hat{D}_{k+f}, Δ\hat{υ}_{(h,t),k+f} accordingly.

Also in various embodiments, estimates are provided as to prediction uncertainties (step 214). In various embodiments, the processor 142 of FIG. 1 estimates prediction uncertainties based on the sensor data of steps 204 and 206, as well as data as to how reliable the sensors are deemed to be, and where along the receding horizon the data is taking place. For example, when particular sensor data is deemed to be less reliable, then the confidence of the particular time-to-event is lessened. Similarly, when particular data pertains to time or distance further along the receding horizon, the confidence with respect to such estimates are similarly lessened. In various embodiments, the prediction uncertainty identification takes all the states of the host and target vehicle into the account including but not limited to vehicles' relative heading, vehicle's angular and translational velocities, and host vehicle driver intent to effectively quantify the impact of these measurement uncertainties in calculating the time-to-event along with the receding horizon.

In various embodiments, during step 216, the prediction uncertainties ascertained in step 214 are used to correct the calculation of the probabilistic time-to-event of step 212 over the adaptive prediction horizon of step 210. In various embodiments, the processor 142 corrects the probabilistic time-to-event of step 212 based on the historic data in the previous steps and comparing with what states that was predicted, as determined in step 214.

In various embodiments, the corrected calculation of the probabilistic time-to-event over the adaptive prediction horizon, as determined during step 216, comprises the probabilistic time-to-event horizon 208, as depicted in FIG. 1. In various embodiments, this value is represented as [symbol] _{k+f}⁻¹.

With continued reference to FIG. 2, a probabilistic risk horizon 218 is generated in steps 220-224 with respect to the probabilistic time-to-event horizon 208. In various embodiments, the probabilistic risk horizon 218 is generated by the processor 142 of FIG. 1 using relative seventies of outcomes of the potential vehicle events associated with the time-to-event horizon 208.

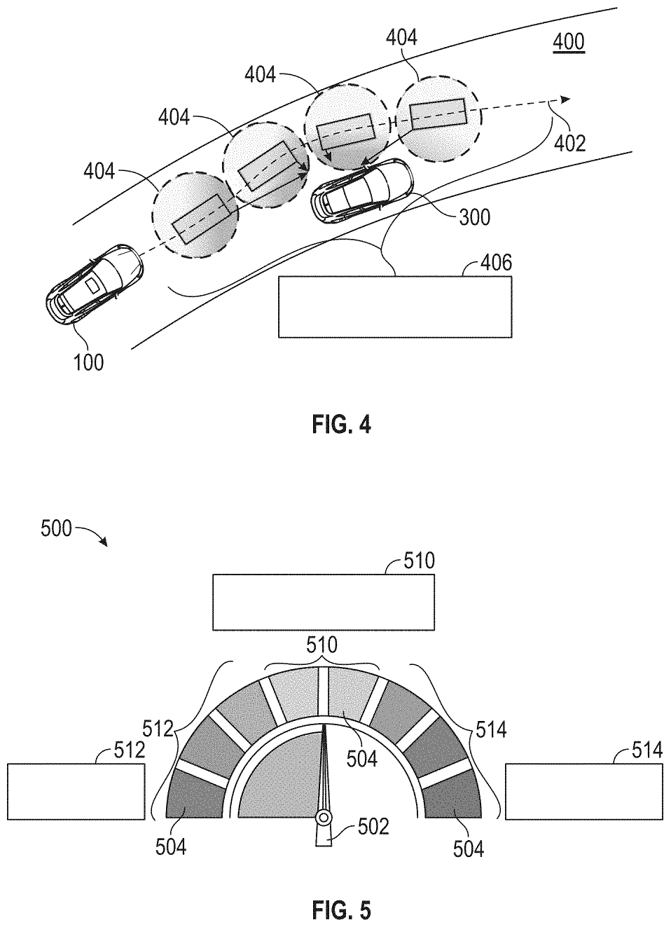

In various embodiments, during step 220, a predictive potential event zone is generated. In various embodiments, the predictive potential event is generated by the processor 142 of FIG. 1 based on probabilistic time-to-event considering all of the sensors, model, and environmental uncertainties. Also in various embodiments, a level of uncertainty is similarly calculated in step 222. These steps will be explained further with an illustration depicted in FIG. 4, in accordance with an exemplary embodiment.

With reference to FIG. 4, the host vehicle 100 is depicted travelling along a roadway 400 along horizon time 402, in proximity to a target vehicle 300. As illustrated in FIG. 4, multiple prediction control points 404 (namely, PC₁, PC₂, PC₃, and PC₄) are utilized with respect to analyzing the adaptive prediction horizon. While four prediction control points 404 are illustrated in FIG. 4, it will be appreciated that any number of prediction control points 404 may be utilized in various embodiments. Also in various embodiments, for each of the prediction control points 404, a respective probabilistic time-to-event is calculated, along with a respective degree of confidence with respect to the calculation. As a result, a probabilistic potential event zone horizon 406 is generated across the various prediction control points 404 in an exemplary embodiment.

With reference back to FIG. 2, in various embodiments, risks associated with the potential vehicle events are calculated (step 224). In various embodiments, the processor 142 of FIG. 1 calculates respective risks (or costs) associated with the various potential events represented in steps 220 and 222, and in general of the probabilistic time-to-event horizon 208, thereby generating the probabilistic risk horizon 218 of FIG. 2.

In various categorizations of the potential events for the adaptive prediction horizon are determined in step 226. In various embodiments, the values of the time-to-event horizon 208 and the probabilistic risk horizon 218 are combined by the processor 142 of FIG. 1 in order to generate categorizations (combining likelihood of probability and severity) of possible events along the adaptive predictive horizon with respect to the host vehicle 100 and the target vehicle. In various embodiments, the categorizations pertain to an urgency and/or severity of appropriate corrective action, for example as described in greater detail further below in connection with FIGS. 3 and 5.

With respect to FIG. 5, an exemplary probabilistic risk horizon 500 is illustrated with respect to the categorization of step 226. In the depicted embodiment of FIG. 5, a needle 502 is shown, and can rotate between any number of possible categories 504 along a continuous spectrum, in accordance with an exemplary embodiment.

For example, in the depicted embodiment of FIG. 5, when the needle 502 points to a category 504 that falls within a first grouping 512, then this is considered to have relatively lower urgency (as compared to groupings 510 and 514), and thus categories 504 in the first grouping 512 may call for a predictive alert to be provided. Accordingly, in certain embodiments, for categories that fall in the first grouping 512, the processor 142 of FIG. 1 may provide instructions for the display system 135 of FIG. 1 to provide one or more audio, visual, haptic, and/or other notifications to the driver or other user of the vehicle 100 (e.g., that a potential vehicle event may occur, and that the driver or other user may want to begin taking appropriate braking, steering, and/or other vehicle actions to help avoid or mitigate such vehicle event).

By way of additional example, also in the depicted embodiment of FIG. 5, when the needle 502 points to a category 504 that falls within a second grouping 510, then this is considered to have relatively medium urgency (i.e., greater than grouping 512 but less than grouping 514), and thus categories 504 in the second grouping 510 may call for automatic mission planning control. Accordingly, in certain embodiments, for categories that fall in the second grouping 510, the processor 142 of FIG. 1 may provide automatic control planning instructions for the braking system 106, the steering system 108, the drive systems 110, and/or one or more vehicle systems (e.g., to provide relatively gradual changes to braking, steering, acceleration (or deceleration) and the like, as compared with more urgent, significant, and/or drastic actions described bully in connection with the third grouping 514) in order to avoid or mitigate the potential vehicle events.

By way of further example, also in the depicted embodiment of FIG. 5, when the needle 502 points to a category 504 that falls within a third second grouping 514, then this is considered to have relatively high urgency (i.e., greater than both the first grouping 512 and the second grouping 510), and thus categories 504 in the third grouping 514 may call for automatic reactive control. Accordingly, in certain embodiments, for categories that fall in the third grouping 514, the processor 142 of FIG. 1 may provide urgent automatic corrective action via instructions for the braking system 106, the steering system 108, the drive systems 110, and/or one or more vehicle systems (e.g., to provide immediate and significant control actions, such as full emergency braking, evasive steering actions to avoid an imminent vehicle event, and the like).

With reference now to FIG. 3, additional an illustration is provided regarding the categorization of step 226. Specifically, the second graphical representation 304 of FIG. 3 illustrates similar groupings as those set forth in FIG. 5. For example, the second graphical representation 304 of FIG. 3 depicts: (i) a first zone (or “alert zone”) 330, with a relatively lower amount of urgency, and in which a predictive alert is provided to the driver or user of the vehicle (i.e., corresponding to the first grouping 512 of FIG. 5); (ii) a second zone (or “planning control zone”) 332, with a relatively medium amount of urgency, and in which gradual planning control is provided by the processor (i.e., corresponding to the second grouping 510 of FIG. 5); and (iii) a third zone (or “reactive control zone”) 334, with a relatively high amount of urgency, and in which reactive control is automatically provided by the processor on an urgent basis (i.e., corresponding to the third grouping 514 of FIG. 5).

With reference back to FIG. 2, vehicle control is exercised (step 228). In various embodiments, the processor 142 of FIG. 1 provides instructions for the braking system 106, steering system 108, drive system 108, the display system 135, and/or one or more other vehicle systems to provide automatic control actions based on the categorization of step 226.

Accordingly, in various embodiments, for categorizations with a relatively lower level of urgency (e.g., considering the time-to-event, the confidence of the prediction, and the potential severity or risk associated with the event, all taken together), such as in the first grouping 512 of FIG. 5, a notification to a driver or other user of the vehicle 100 may be provided in certain embodiments.

Likewise, also in various embodiments, for categorizations with a relatively medium level of urgency (e.g., considering the time-to-event, the confidence of the prediction, and the potential severity or risk associated with the event, all taken together), such as in the second grouping 510 of FIG. 5, the processor 142 may implement automatic mission planning control (e.g., for relatively gradual adjustments to path planning, steering, braking, acceleration, deceleration, and the like).

Also in various embodiments, for categorizations with a relatively higher level of urgency (e.g., considering the time-to-event, the confidence of the prediction, and the potential severity or risk associated with the event, all taken together), such as in the third grouping 514 of FIG. 5, the processor 142 may implement reactive vehicle control, for example through urgent and/or immediate changes to vehicle control (e.g., full emergency braking, evasive steering maneuvers, and the like).

Furthermore, in various embodiments, when automatic control is called for (e.g., with respect to the second grouping 510 and the third grouping 514 of FIG. 5), in various embodiments the processor 142 of FIG. 1 provides instructions for both lateral and longitudinal control, via instructions to both the braking system 106 and the steering system 108, for braking and steering adjustments together to optimize the effort to control (e.g., avoid and mitigate) potential vehicle events.

In certain embodiments, the vehicle control is provided based on a desired wheel angle δₜ to avoid a vehicle event, that is found based on the following equation:

$${min}_{{δ}_{t}} {\sum }_{t \geq 0} g ( , e , {δ}_{t} ( e ) ) , \qquad ( Equation 8 )$$

subject to:

ė=M₁e+M₂δₜ+M₃ρ+M₄(θ)+\tilde{e} (Equation 9) and

α₁e+α₂δₜ≤c,∀\tilde{e} (Equation 10),

where M₁, . . . , M₅ are vehicle parameters for vehicle lateral error dynamics, δₜ is the desired road wheel angle, which is the control command, ρ is desired curvature, θis the road's bank angle, and \tilde{e} is the uncertainty in the error dynamics.

However, in various embodiments, the specific manner of vehicle control may vary, for example based on the categorization of step 226, described above.

In various embodiments, the method then terminates at step 230.

Accordingly, methods, systems, and vehicles are provided for controlling vehicles while avoiding or mitigating vehicle events with target vehicles. In various embodiments, an adaptive prediction horizon is predicted in front of the vehicle, and a probabilistic time-to-event is calculated at various control points along a receding prediction horizon in front of the vehicle. Also in various embodiments, the time-to-event along the prediction horsing is adjusted based on a level of confidence in the predictions and the potential risk of such a vehicle event, in order to provide appropriate vehicle control to avoid or mitigate the vehicle event. In various embodiments, the techniques described herein provide for a reactive approach to avoid or mitigate potential vehicle events with greater lead time as compared with other techniques, for example using the advanced and updated probabilistic approach.

It will be appreciated that the systems, vehicles, and methods may vary from those depicted in the Figures and described herein. For example, the vehicle 100 of FIG. 1, and the control system 102 and components thereof, may vary in different embodiments. It will similarly be appreciated that the steps of the process 200 may differ from those depicted in FIG. 2, and/or that various steps of the process 200 may occur concurrently and/or in a different order than that depicted in FIG. 2. It will similarly be appreciated that the various implementations of FIGS. 3-5 may also differ in various embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A system comprising:
one or more first sensors onboard a host vehicle and configured to at least facilitate obtaining first sensor data with respect to the host vehicle;
one or more second sensors onboard the host vehicle and configured to at least facilitate obtaining second sensor data with respect to a target vehicle that is in proximity to the host vehicle; and
a processor that is coupled to the one or more first sensors and the one or more second sensors and that is configured to at least facilitate:
creating an adaptive prediction horizon that includes a probabilistic time-to-event horizon with respect to possible vehicle events between the host vehicle and the target vehicle; and
controlling the host vehicle based on the probabilistic time-to-event horizon.

2. The system of claim 1, wherein the processor is further configured to at least facilitate simultaneously controlling lateral and longitudinal movement of the host vehicle based on the probabilistic time-to-event horizon.

3. The system of claim 1, wherein the processor is further configured to at least facilitate:
estimating prediction uncertainties for the adaptive predictive risk horizon, using respective uncertainties associated with one or more of the first sensors, second sensors, or both;
generating a corrected probabilistic time-to-event horizon using the prediction uncertainties; and
controlling the host vehicle based on the corrected probabilistic time-to-event horizon.

4. The system of claim 1, wherein the processor is further configured to at least facilitate:
generating a probabilistic risk horizon for the adaptive prediction horizon; and
controlling the host vehicle based on both the probabilistic time-to-event horizon and the probabilistic risk horizon.

5. The system of claim 4, wherein the processor is further configured to at least facilitate:
generating a predictive potential event zone using the first sensor data and the second sensor data; and
calculating a risk of specific events associated with the potential event zone.

6. The system of claim 4, wherein the processor is further configured to at least facilitate:
generating a category for control based on both the probabilistic time-to-event horizon and the probabilistic risk horizon; and
controlling the host vehicle based on both the probabilistic time-to-event horizon and the probabilistic risk horizon, based on the category for control.

7. The system of claim 6, wherein the processor is further configured to at least facilitate generating the category for control from a plurality of different category groupings, including:
a first category grouping representing a first level of urgency, and calling for a notification to be provided to a driver or other user of the host vehicle;
a second category grouping representing a second level of urgency, greater than the first level of urgency, and calling for mission planning control to be provided for the host vehicle in accordance with instructions provided by the processor; and
a third category grouping representing a third level of urgency, greater than both the first level of urgency and the second level of urgency, and calling for reactive planning control to be provided for the host vehicle in accordance with instructions provided by the processor.

8. The system of claim 1, wherein the processor is further configured to at least facilitate controlling steering for the host vehicle based on the probabilistic time-to-event horizon.

9. The system of claim 1, wherein the processor is further configured to at least facilitate controlling lateral and longitudinal movement of the host vehicle based on the probabilistic time-to-event horizon.

10. A method comprising:
obtaining first sensor data with respect to a host vehicle, from one or more first sensors onboard the host vehicle;
obtaining second sensor data with respect to a target vehicle that is in proximity to the host vehicle, form one or more second sensors onboard the host vehicle;
creating, via a processor onboard the host vehicle, an adaptive prediction horizon that includes a probabilistic time-to-event horizon with respect to possible vehicle events between the host vehicle and the target vehicle; and
controlling the host vehicle based on the probabilistic time-to-event horizon via instructions provided by the processor.

11. The method of claim 10, wherein the step of controlling the host vehicle comprises providing a notification to a user of the host vehicle, in accordance with instructions provided by the processor, based on the probabilistic time-to-event horizon.

12. The method of claim 10, wherein the step of controlling the host vehicle comprises simultaneously controlling lateral and longitudinal movement of the host vehicle, in accordance with instructions provided by the processor, based on the probabilistic time-to-event horizon.

13. The method of claim 10, further comprising:
estimating, via the processor, prediction uncertainties for the adaptive predictive risk horizon, using respective uncertainties associated with one or more of the first sensors, second sensors, or both; and
generating, via the processor, a corrected probabilistic time-to-event horizon using the prediction uncertainties;
wherein the step of controlling the host vehicle comprises controlling the host vehicle based on the corrected probabilistic time-to-event horizon.

14. The method of claim 10, further comprising;
generating, via the processor, a probabilistic risk horizon for the adaptive prediction horizon;
wherein the step of controlling the host vehicle comprises controlling the host vehicle based on both the probabilistic time-to-event horizon and the probabilistic risk horizon, via instructions provided by the processor.

15. The method of claim 14, wherein the generating of the problematic risk horizon comprises:
generating a predictive potential event zone using the first sensor data and the second sensor data; and
calculating a risk of specific events associated with the potential event zone.

16. The method of claim 14, further comprising;
generating, via the processor, a category for control based on both the probabilistic time-to-event horizon and the probabilistic risk horizon;
wherein the step of controlling the host vehicle comprises controlling the host vehicle based on both the probabilistic time-to-event horizon and the probabilistic risk horizon, via instructions provided by the processor, with the instructions based on the category for control.

17. The method of claim 14, wherein the category for control is generated from a plurality of different category groupings, including:
a first category grouping representing a first level of urgency, and calling for a notification to be provided to a driver or other user of the host vehicle;
a second category grouping representing a second level of urgency, greater than the first level of urgency, and calling for mission planning control to be provided for the host vehicle in accordance with instructions provided by the processor; and
a third category grouping representing a third level of urgency, greater than both the first level of urgency and the second level of urgency, and calling for reactive planning control to be provided for the host vehicle in accordance with instructions provided by the processor.

18. A vehicle comprising:
a body;
a propulsion system configured to generate movement of the body;
one or more first sensors onboard a host vehicle and configured to at least facilitate obtaining first sensor data with respect to the host vehicle;
one or more second sensors onboard the host vehicle and configured to at least facilitate obtaining second sensor data with respect to a target vehicle that is in proximity to the host vehicle; and
a processor that is coupled to the one or more first sensors and the one or more second sensors and that is configured to at least facilitate:
creating an adaptive prediction horizon that includes a probabilistic time-to-event horizon with respect to possible vehicle events between the host vehicle and the target vehicle; and
controlling the host vehicle based on the probabilistic time-to-event horizon.

19. The vehicle of claim 18, wherein the processor is further configured to at least facilitate:
estimating prediction uncertainties for the adaptive predictive risk horizon, using respective uncertainties associated with one or more of the first sensors, second sensors, or both;
generating a corrected probabilistic time-to-event horizon using the prediction uncertainties; and
controlling the host vehicle based on the corrected probabilistic time-to-event horizon.

20. The vehicle of claim 18, wherein the processor is further configured to at least facilitate:
generating a probabilistic risk horizon for the adaptive prediction horizon; and
controlling the host vehicle based on both the probabilistic time-to-event horizon and the probabilistic risk horizon.
